(19) United States
(12) Patent Application Publication
(10) Pub. No.: US 2009/0289473 A1
(43) Pub. Date: Nov. 26, 2009

(54) KEY CAM SYSTEM FOR HOOD HINGE WITH ACTIVE PEDESTRIAN PROTECTION SYSTEM

(75) Inventor: Ryan F. Kmieciak, Redford, MI (US)

Correspondence Address: RADER, FISHMAN & GRAUER PLLC, 39533 WOODWARD AVENUE, SUITE 140, BLOOMFIELD HILLS, MI, 48304-0610, US

(73) Assignee: Edscha North America

(21) Appl. No.: 12/124,651

(22) Filed: May 21, 2008

(51) Int. Cl. B60R 21/34; E05D 11/10

(52) U.S. Cl. 296/193.11; 16/343

(57) ABSTRACT

A hinge mechanism for deploying a vehicle pedestrian protection system is provided, including a first hinge element, a second hinge element and a earn assembly. The hinge mechanism includes a closed position and an open position, wherein at least a portion of the first hinge element and the second hinge element separate from one another when the hinge mechanism is urged from the closed position to the open position. The cam assembly includes a cam and a retaining mechanism, where the cam is connected to the first hinge element and the retaining mechanism is connected to the second hinge element. The retaining mechanism is guided within the cam between a first cam position corresponding to the closed position and a second cam position corresponding to the open position.

### TECHNICAL FIELD

The present disclosure relates to a hinge mechanism, and in particular to hinge mechanisms related to a vehicle.

### BACKGROUND

In recent years, some vehicles have included pedestrian protection systems that reduce the likelihood of injuries to pedestrians in the unfortunate event the vehicle hits a pedestrian in an accident. The pedestrian protection system is designed such that a hood of the vehicle absorbs an impact force that is generated by the pedestrian hitting the hood during the accident.

In one approach, a pedestrian protection system includes a pocket of empty space between a vehicle hood selectively enclosing an engine compartment and the engine components contained within the engine compartment. The pocket of space may be located adjacent to the cowl and the windshield of the vehicle, and generally opposite to a hood latch used to selectively engage the hood with the rest of the engine compartment. The pocket of space is intended to act as a cushion between the engine compartment components and the pedestrian, hopefully absorbing at least a portion of an impact force.

Including such a pocket of space at all times has become more and more difficult because of other constraints, not the least of which include vehicle weight, vehicle size, and vehicle aerodynamics or styling.

Accordingly, in accordance with another approach, the pedestrian protection system includes a deployable hood that is raised during an accident for creating the pocket of space. More specifically, in the event a pedestrian is impacted by the vehicle, the pedestrian protection system raises the hood upwardly and away from the vehicle's fenders.

There are several types of hinge mechanisms for a pedestrian protection system that may facilitate deployment of the hood in the event a pedestrian and a vehicle come into contact. However, each of these mechanisms includes disadvantages. For example, in one approach, the pedestrian protection system includes a specialized latching system that is used to deploy the hinge mechanism. Under normal operation, the specialized latching system maintains the hinge mechanism in a closed non-air space orientation. One drawback of using this latching system is that once the hinge mechanism is deployed, such a specialized latching system will not allow for a user to completely return the hinge to its original pre-deployed closed non-air space orientation. For example, the hood may not be flush with the fenders. The latching system may require specialized expertise to repair and thereby completely shut the hood back to the original, pre-deployed position. Further, until the latching system is repaired, the hood orientation may inadvertently compromise sight lines associated with vehicle operation.

In another approach, the latching system includes a pin that is used to reset the hinge mechanism. After the hood has been deployed, the user must manually remove the pin from a mating hole to reposition the hood back to the original pre-deployed closed non-air space orientation. However, it is more desirable to design a latching system that only requires applying a downwards force to the top surface of the hood for repositioning, because the process of resetting the hinge mechanism with the pin and the mating hole may be inconvenient and cumbersome for the user.

Accordingly, there is a need for a hinge mechanism that minimizes the amount of user intervention when repositioning the hood after deployment, while still allowing the hinge mechanism to shut completely such that the hood is flush with the fenders of the automobile.

### BRIEF DESCRIPTION OF THE DRAWINGS

FIG. 1A is a partially sectioned view of a vehicle including a pedestrian protection system, where a hood of the vehicle is in a pre-deployed position;

FIG. 1B is a partially sectioned view of the vehicle in FIG. 1A, where a hinge mechanism of the protection system positions the hood in a deployed position;

FIG. 2A is an enlarged, partially sectioned view of the hinge mechanism of the protection system in a closed position and including a cam assembly;

FIG. 2B is an enlarged, partially sectioned view of the hinge mechanism of FIG. 2A in an open position;

FIG. 3 is an alternative illustration of the hinge mechanism as seen in FIG. 2A, in the closed position;

FIG. 4 is an enlarged, partially sectioned view of the cam assembly in FIG. 2A, where a pin of the cam assembly is in a first position;

FIG. 5 is an enlarged, partially sectioned view of the cam assembly in FIG. 2B, where the pin of the cam assembly is in a second position;

FIG. 6 is an enlarged, partially sectioned view of the cam assembly where the pin of the cam assembly is in a third position, and the protection system is in the closed position;

FIG. 7A is a partially sectioned view of an opposite side of the hinge mechanism as seen in FIG. 4;

FIG. 7B is a partially sectioned view of an opposite side of the hinge mechanism as seen in FIG. 5;

FIG. 8 is a partially exploded view of the cam assembly and a first hinge strap of the hinge mechanism; and

FIG. 9 is a process flow diagram of a method of deploying the hood of the vehicle by the hinge mechanism.

### DETAILED DESCRIPTION

Referring now to the discussion that follows and also to the drawings, illustrative approaches to the disclosed systems and methods are shown in detail. Although the drawings represent some possible approaches, the drawings are not necessarily to scale and certain features may be exaggerated, removed, or partially sectioned to better illustrate and explain the present disclosure. Further, the descriptions set forth herein are not intended to be exhaustive or otherwise limit or restrict the claims to the precise forms and configurations shown in the drawings and disclosed in the following detailed description.

Moreover, a number of constants may be introduced in the discussion that follows. In some cases illustrative values of the constants are provided. In other cases, no specific values are given. The values of the constants will depend on characteristics of the associated hardware and the interrelationship of such characteristics with one another as well as environmental conditions and the operational conditions associated with the disclosed system.

According to various exemplary illustrations described herein, a hinge mechanism for selectively deploying a vehicle pedestrian protection system is provided, and may include a first hinge element and a second hinge element. The hinge mechanism may also include a closed position and an open position, where at least a portion of the first hinge element and at least a portion of the second hinge element separate from one another when the hinge mechanism is urged from the closed position to the open position.

A cam assembly including a cam and a retaining mechanism may also be provided. The cam may include a pivot point and is selectively rotated about the pivot point. The cam is connected to the first hinge element and the retaining mechanism is connected to the second hinge element. The cam may include a first cam position corresponding to the closed position of the hinge mechanism and a second cam position corresponding to the open position of the hinge mechanism. The retaining mechanism may be guided within the cam between the first cam position and the second cam position. The cam may include a passageway, where the retaining mechanism is guided within the passageway between the first cam position and the second cam position. The cam is configured for rotating about the pivot point when the hinge mechanism is urged from the closed position into the open position. Rotation of the cam moves the retaining mechanism from the first cam position to the second cam position. The cam assembly may also include a biasing mechanism for exerting a biasing torque upon the cam. The biasing torque urges the cam to rotate about the pivot point.

A method of deploying a hood of a vehicle pedestrian protection system by the hinge mechanism is also disclosed. The method may include providing a hinge mechanism that is urged from a closed position to an open position for deploying the hood of the vehicle pedestrian protection system. As the hinge mechanism is urged open, at least a portion of a first hinge element and a second hinge element of the hinge mechanism separate from one another. A biasing torque from a biasing mechanism may be exerted upon a cam, where the cam is connected to the first hinge element and the biasing mechanism is in communication with the cam. The cam may be rotated about a pivot point by way of the biasing torque. A retaining mechanism may be guided inside of a passageway located in the cam. The retaining mechanism may be slid from a first cam position to a second cam position, where the retaining mechanism is connected to the second hinge element, and the first and second cam positions may be located along the passageway. The retaining mechanism may be located at the first cam position when the hinge mechanism is in the closed position and in the second cam position when the hinge mechanism is in the open position. The hinge mechanism is secured in place in the open position when the retaining mechanism is in the second cam position.

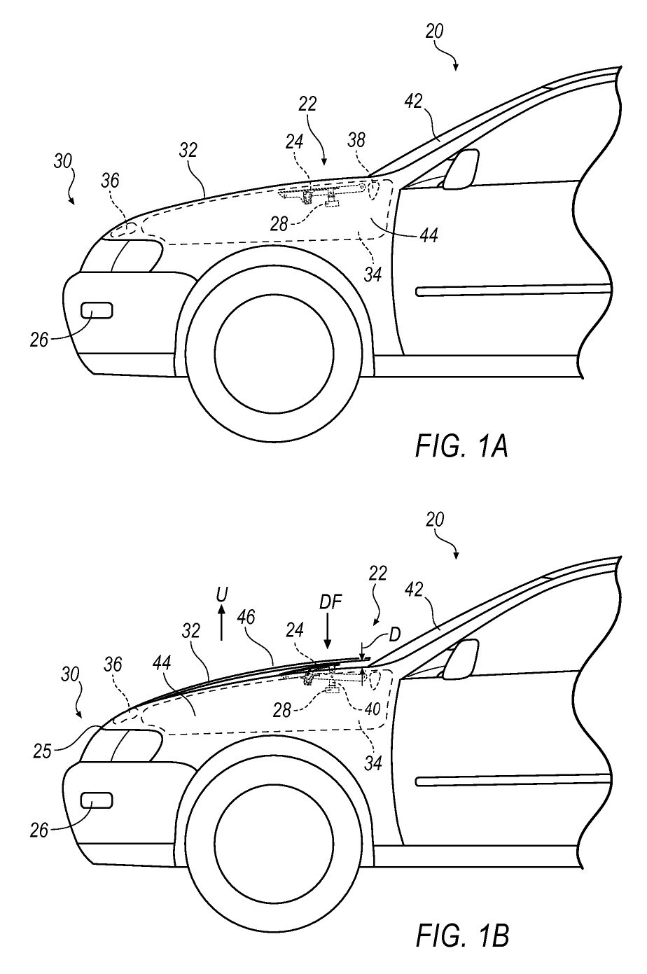

Turning now to the drawings and in particular to FIG. 1A, an exemplary vehicle 20 including a pedestrian protection system 22 is disclosed. The protection system 22 is located underneath a hood 32 and inside of an engine compartment 34 of the vehicle 20. The protection system 22 may include a hinge mechanism 24, a crash sensor 26 and an actuator 28. The crash sensor 26 may be mounted at a front end 30 of the vehicle 20 and detects when the front end 30 of the vehicle 20 makes contact with a foreign object such as a human body (not shown) in an automobile-pedestrian accident. In one example, the crash sensor 26 may be able to discriminate between an inanimate object and a living being, such as a human body. When an inanimate object is contacted by the front end 30, the protection system 22 may not deploy into the position as seen in FIG. 1B, which is discussed in greater detail below. Thus, if the vehicle 20 makes contact with an object such as a telephone pole instead of a human body, the protection system 22 may not deploy.

In the illustration as shown, the hood 32 is in a pre-deployed position. That is, the hood 32 of the vehicle 20 is shut closed. In the event the front end 30 contacts an obstruction, the hood 32 will be deployed by the protection system 22, as seen in FIG. 1B. The hood 32 is opened, and urged in an upwards direction U by way of the hinge mechanism 24 that is in communication with the hood 32. The hinge mechanism 24 is in communication with the actuator 28. The actuator 28 receives a communication from the crash sensor 26 (e.g. an electronic signal), and when an object is contacted by the front end 30, the crash sensor 26 sends a communication such as an electronic signal to the actuator 28. The communication drives a shaft 40 of the actuator 28 in the direction U, thereby deploying the hinge mechanism 24, as discussed in greater detail below.

As seen in FIG. 1B, the hood 32 is deployed in the direction U such that the hood 32 is not flush with a fender 44 of the vehicle 20. More specifically, as seen in FIG. 1A, the hood 32 is in a pre-deployed position and is flush with the fender 44. FIG. 1B illustrates the hood 32 in a deployed position and raised at a predetermined distance D from the fender 44. In one illustration, the distance D between the hood 32 and the fender 44 is between about two inches (2.0 in) to about four inches (4.0 in) (50.0 millimeters to about 100.0 millimeters). The distance D depends on the type and model of the vehicle 20.

The hinge mechanism 24 may be located in a position that is generally opposite to a hood latch 36 inside of the engine compartment 34 and adjacent to a cowl 38. Thus, when the hood 32 is deployed, the predetermined distance D may be located adjacent to a windshield 42 and located generally opposite the hood latch 36. That is, the hood 32 may be raised by the hinge mechanism 32 in a direction that generally opposes a seam 25 of the hood 32 that is located along the front end 30. The seam 25 is interrupted when the hood 32 is traditionally opened for servicing meaning that the hood is raised away from the fenders 44. For example, when a user desires to check the oil, or perform maintenance to the underhood engine components such as the engine (not shown), the user detaches the hood latch 36 from the hood 32, and raises the hood 32 upwardly.

After the hood 32 is deployed by the protection system 22, a user may selectively apply a downward force DF along an outer surface 46 of the hood 32. The downward force DF urges the hood 32 from the deployed position as seen in FIG. 1B to a post-deployment position, similar to the configuration as seen in FIG. 1A. More specifically, the post-deployment position of the hood 32 may be locationally very close to or about the same as the pre-deployment position of the hood 32. Thus, in the event the vehicle 20 is involved in an automobile-pedestrian accident, or if the actuator 28 misfires, the user may reposition the hood 32 such that the hood 32 is flush with the fender 44. However, it should be noted that while the hood 32 may be repositioned back into the pre-deployment position, the protection system 22 is unable to deploy and raise the hood 32 again until the vehicle 20 receives specialized servicing, as discussed in greater detail below.

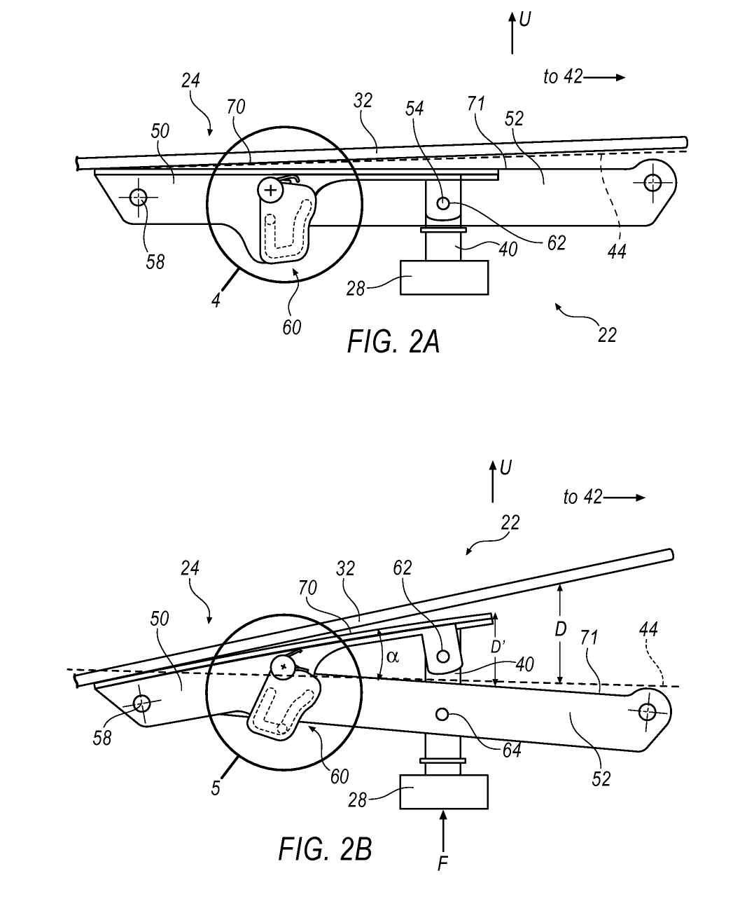

FIG. 2A illustrates the protection system 22 and the hood 32 in the pre-deployment position. In the illustrated example, the hinge mechanism 24 includes a first hinge element illustrated as a first hinge strap 50, a second element in the form of a second hinge strap 52, a shear pin 54, and a common pivot point 58, and a cam assembly 60. The shear pin 54 may be inserted within an aperture 62 of the first hinge strap 50 and an aperture 64 of the second hinge strap 52 (the aperture 64 is best seen in FIG. 2B). It should be noted that although the illustration only includes the first and second hinge straps 50 and 51, more than two elements may be used including more than two hinge straps.

In the illustration as shown, the hinge mechanism 24 is secured in a closed position. That is, the first hinge strap 50 may be generally aligned with the second hinge strap 52, and the hood 32 is in the pre-deployed position. FIG. 2A also illustrates an upper surface 70 of the first hinge strap 50 that may be generally parallel with an upper surface 71 of the second hinge strap 52. However, as discussed below, the hinge mechanism 24 may be secured in the closed position even when the first hinge strap 50 and the second hinge strap 52 are not generally aligned with one another.

The cam assembly 60 cooperates with both the actuator 28 and the shear pin 54. The first and second hinge straps 50 and 52 may limit rotation of the hinge mechanism 24 during deployment. The cam assembly 60 may also limit rotation of the hinge mechanism 24 during deployment as well, and operation of the hinge mechanism 24 in relation to the cam assembly 60 is discussed in greater detail below. More specifically, rotation of the hinge mechanism 24 is limited between the position as seen in FIG. 1A where the hood 32 is flush with the fender 44, and the position as seen in FIG. 1B where the hood 32 is raised at the distance D from the fender 44.

Indeed, as seen in FIG. 2B, when the actuator 28 drives the shaft 40 in the direction U, an upwards force F may be exerted from the shaft 40 and urges the hood 32 into the deployed position. The upwards force F may be greater than a threshold of a predetermined shear load of the shear pin 54. The shear pin 54 retains the hinge mechanism 24 in the closed position, and if the force F is greater than a threshold value of the predetermined shear load, the shear pin 54 is broken. When the shear pin 54 is broken, the hinge mechanism 24 is urged into an open position by the upwards force F that is exerted from the shaft 40. The upper surface 70 of the first hinge strap 50 makes contact with and urges the hood 32 upwardly in the direction U when the hinge mechanism 24 is opened. The hood 32 is raised the distance D from the fender 44 when in the deployed position. The first hinge strap 50 may be separated at a predetermined distance D′ from the second hinge strap 52 as well when the hinge mechanism 24 is in the open position. In the illustration as shown, the distance D′ may be measured from the upper surface 70 of the first hinge strap 50 to the upper surface 71 of the second hinge strap 52 and taken using a free end of the strap 50.

When the first hinge strap 50 of the hinge mechanism 24 is raised at the predetermined distance D′, the hinge mechanism 24 may be in the open position. That is, the upper surface 70 of the first hinge strap 50 may no longer generally parallel and in the same orientation with the upper surface 71 of the second hinge strap 52, and the first hinge strap 50 may be positioned at an angle from the second hinge strap 52. More specifically, the predetermined distance D′ may be formed by an angle α that may be located between the upper surface 70 of the first hinge strap 50 to the upper surface 71 of the second hinge strap 52.

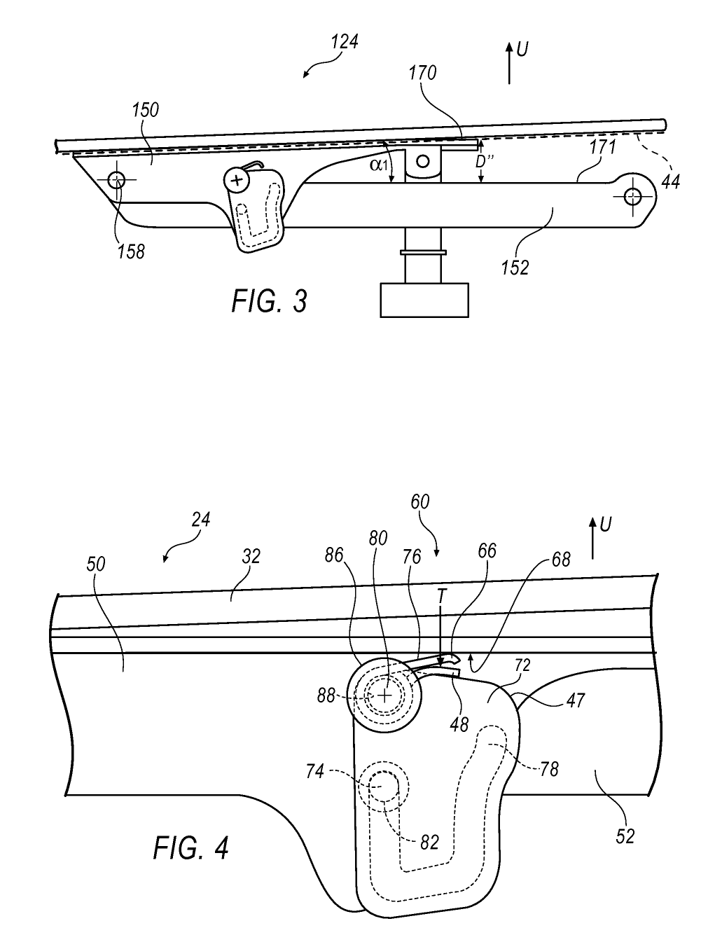

At least a portion of the first hinge strap 50 and the second hinge strap 52 rotate about the common pivot point 58, and separate from one another when the hinge mechanism 24 is urged from the closed position to the open position. It should be noted that while FIG. 2A illustrates the first hinge strap 50 and the second hinge strap 52 generally aligned with one another, a vertical distance may also be included between the upper surfaces 170 and 171 of the first and second hinge straps 150 and 152, as seen in the alternative illustration of FIG. 3.

FIG. 3 is an alternative illustration of the protection system 122 including the hinge mechanism 124 in the closed position. The vertical distance, illustrated as the predetermined distance D″ may be located between the first hinge strap 150 and the second hinge strap 152. The predetermined distance D″ may increase between the first and second hinge straps 150 and 152 as the hinge mechanism 124 is urged into the open position. Moreover, the first hinge strap 150 may be angled from the second hinge strap 152 when the hinge mechanism 24 is in the closed position. In the illustration as shown, the angle α′ is located between the first hinge strap 150 and the second hinge strap 152. When the hinge mechanism 124 is urged in the open position, the angle α′, as well as the predetermined distance D″ may increase between the first hinge strap 150 and the second hinge strap 152. More specifically, the predetermined distance D″ is measures from the upper surface 170 of the first hinge strap 150 and the upper surface 171 of the second hinge strap 152 and taken using the free end of the strap 150.

Operation of the cam assembly 60 in relation to the first hinge strap 50 and the second hinge strap 52 will now be discussed. FIG. 4 is an enlarged, partially cross sectioned view of the cam assembly 60 as seen in FIG. 2A. That is, the hinge mechanism 24 is in the closed, pre-deployed position. The cam assembly 60 includes a cam 72, at least one retaining mechanism that is illustrated as a pin 74, and at least one biasing mechanism that is illustrated as a torsion spring 76. Although FIG. 4 illustrates a torsion spring and a pin, it is understood that various biasing mechanisms and various retaining mechanisms for the cam assembly 60 may be used as well. The cam 72 includes a passageway illustrated as a key-way channel 78 and at least one pivot point 80. The pin 74 is in sliding engagement with the channel 78, and is configured to slide within the channel 78 when the cam 72 selectively rotates about the pivot point 80.

Although FIG. 4 illustrates the pin 74 being guided inside a key-way channel 78, any passageway that facilitates the pin 74 being guided within the cam 72 may be used. In one illustrative example, the channel may be a thru-way slot that is used to guide the pin 74. The cam 72 may be constructed from a material with a low coefficient of friction that will facilitate sliding the pin 74 along the channel 78 such as, but not limited to, a polymer or a metal. In one illustration, the cam 72 may be constructed from a self-lubricating plastic.

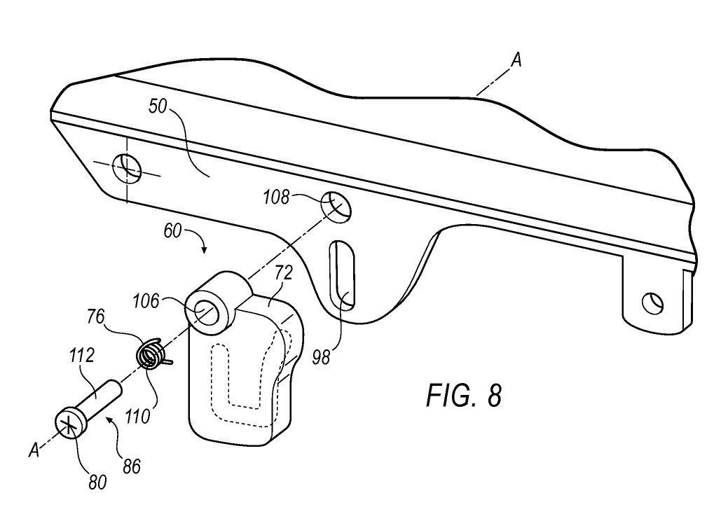

In the illustration as shown, the pivot point 80 may be a pivotable pin 86 that is received by the cam 72. Indeed, as best seen in FIG. 8, and as discussed in greater detail below, the cam 72 includes a mating hole 106 that receives the pivotable pin 86. It should be noted that while FIG. 4 illustrates the pivot point 80 as the pivotable pin 86, any device that is received by allows for the cam 72 to rotate about the pivot pin 80 may be used as well.

FIG. 4 illustrates the pin 74 located at a first position 82 along the channel 78, where the first position 82 corresponds to the hinge mechanism 24 in the closed position. It should be noted that while FIG. 4 illustrates the channel 78 shaped in a generally J-shaped configuration, the channel 78 may be shaped in any configuration that will facilitate the opening and closing of the hinge mechanism 24.

The spring 76 may be in communication with the cam 72 for exerting a biasing force upon the cam 72, which is discussed in detail below. In the illustration as shown, the spring 76 may be wound about a shaft 88 of the pivotable pin 86. A first end 66 of the spring 76 may rest along a side surface 68 of the first hinge strap 50, and a second end 48 of the spring 76 may be in contact with an outer surface 47 of the cam 72. The first end 66 and the second end 48 are bindingly engaged by the side surface 68 of the first hinge strap 50 and the outer surface 47 of the cam 72 respectively. Because the spring 76 exerts a biasing torque, illustrated as a spring torque T upon the cam 72, the pin 74 selectively moves within the channel 78. The cam 72 is configured to rotate forward (with respect to vehicle 20) about the pivot point 80.

When the shear pin 54 is broken, the hinge mechanism 24 is urged in the direction U (seen in FIG. 2B) and into the open position. As the hinge mechanism 24 is urged upwardly in the direction U, the second end 48 of the spring 76 exerts the torque T upon the cam 72 and urges the pin 74 into a second position 90 inside the channel 78, as discussed below.

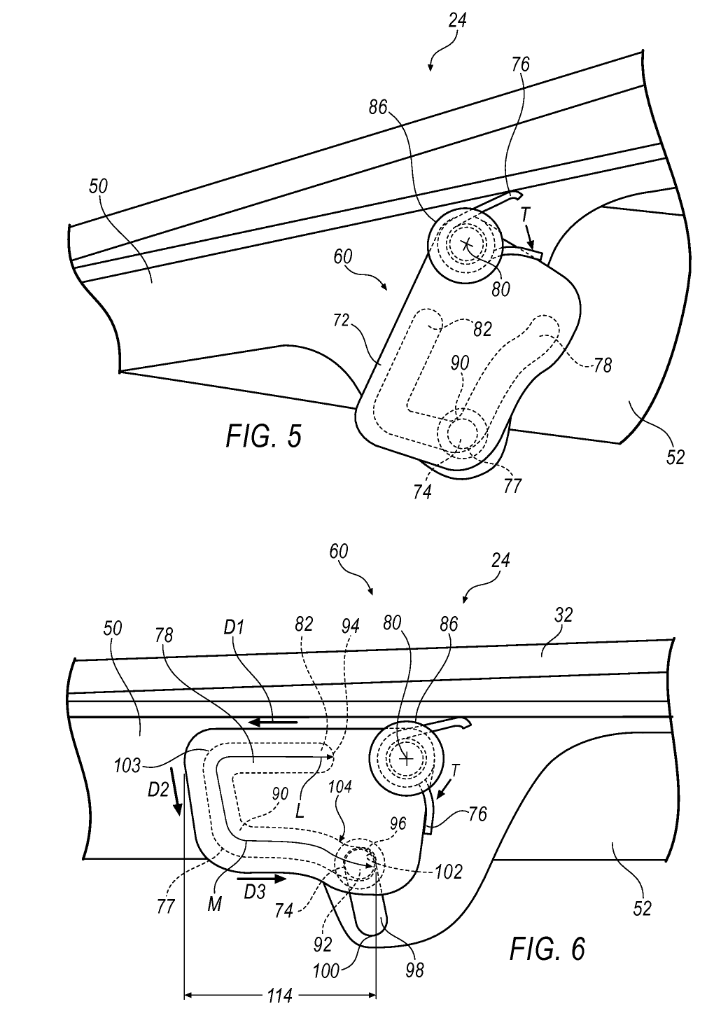

FIG. 5 is an enlarged, partially cross sectioned view of the cam assembly 60 as seen in FIG. 2B where the cam assembly 60 is in the open position. That is, the pin 74 is located at the second position 90 when the hinge mechanism 24 is open. The torque T exerted by the spring 76 urges the cam 72 to rotate about the pivot point 80. When the cam 72 is rotated, the pin 74 is guided within the channel 78 from the first position 82 to the second position 90. More specifically, FIG. 5 illustrates the pin 74 inside of the channel 78 after the pin 74 has traveled from the first position 82 to the second position 90. The engagement of the cam 72 and the pin 74 in the second position 90 aids in securing the hinge mechanism 24 in the open position.

The channel 78 may also include geometry that facilitates retention of the pin 74 inside of the channel 78 and limits rotation of the hinge mechanism 24. More specifically, the pin 74 is located at the second position 90, which may include specialized features to aid in securing the second hinge strap 52 at the predetermined distance D′ from the first hinge strap 50 when the hinge mechanism 24 is opened. For example, as seen in FIG. 5, the channel 78 may include a turn 77, which assists in retaining the pin 74 in place when the pin 74 is in the second position 90. Moreover, as discussed in greater detail below, the first hinge strap 50 may also include a slotted hole 98 that is used for securing the hinge mechanism 24 in the open position, and limits deployment travel between the first hinge strap 50 and the second hinge strap 52 to the predetermined distance D′.

As discussed above, after the hood 32 is deployed, a user may selectively apply the downward force DF along the outer surface 46 of the hood 32 to urge the hood 32 from the deployed position as seen in FIG. 1B to a configuration that is locationally similar to the pre-deployment configuration as seen in FIG. 1A. The channel 78 includes the third position 92, as seen in FIG. 6, which may be used to reposition the hood 32 after deployment and to close the hinge mechanism 24.

In the illustration as shown in FIG. 6, the channel 78 includes an overall length L, which is the distance between the first position 82 and the third position 92. The channel 78 may also include a first end 94 which corresponds to the first position 82, and a second end 96 which corresponds to the third position 92. The pin 74 is slidable between the first end 94 and the second end 96. FIG. 6 illustrates the second position 90 located at a midpoint M of the channel 78 between the first position 82 and the third position 92. The midpoint M is about half of the overall length L of the channel 78.

Thus, as may be seen in FIG. 4, the pin 74 may be in the first position 82 prior to deployment of the hood 32. When the shaft 40 of the actuator 28 exerts the upwards force F, the hinge mechanism 24 may be urged open and to deploy the hood 32, and the pin 74 may be guided from the first position 82 to the second position 90, as seen in FIG. 5. The pin 74 travels inside of the channel 78 in two different directions in order to reach the second position 90. As best seen in FIG. 6, the pin 74 first travels in a first direction D1. In the illustration as shown, D1 may be substantially parallel with the upper surface 70 of the first hinge strap 50. The pin 74 may be slid past a first corner 103 of the channel 78. The pin 74 is then guided along the channel at a second direction D2. In one example, the second direction D2 may be located in a direction that is angled at least ninety degrees (90°) from the first direction D1. In the illustration as shown, the second direction D2 is approximately one-hundred and twenty degrees (120°) from the first direction D1. The second position 90 may be located along the turn 77, where the pin is guided along the channel 78 and rests at the turn 77 when the pin 74 is in the second position 90.

The pin 74 is urged into the third position 92 as a user applies the downward force DF along the outer surface 46 of the hood 32 to shut the hinge mechanism 24, as seen in FIG. 1B. The pin 74 travels inside of the channel 78 at a third direction D3. In the illustration as shown, the third direction D3 may be substantially parallel with the first direction D1. Travel of the pin 74 along the third direction D3 may be terminated when the pin 74 reaches the second end 96 of the channel 78.

Although the hood 32 is closed shut when the pin 74 is in the third position 92, the protection system 22 may be unable to deploy the hood 32 again until the vehicle 20 is serviced. The protection system 22 is unable to deploy again because the shear pin 54 is broken and because the pin 74 needs to be re-positioned back to the third position 92. Thus, during servicing at least the shear pin 54 is replaced and the cam 72 is repositioned back to the first position 82 so that the protection system 22 may be deployed again. The cam system 60 is repositioned by rotating the cam 72 in an opposite direction from the first, second and third positions D1, D2 and D3, thereby sliding the pin 74 from the third position 92 to the first position 82. This repositioning may be done manually, that is, no special tools or equipment may be needed to slide the pin 74 inside of the channel 78.

The third position 92 of the channel 78 may be different from the first position 82. Indeed, even though the hood 32 is closed shut when the cam 72 is in both of the first position 82 and the third position 92, the first position 82 may still be located at a different location inside of the channel 78 than the third position 92. When the shear pin 54 is broken, the cam 72 is unable to retain the pin 74 in the first position 82. More specifically, the cam 72 is unable to lock the hinge mechanism 24 in the closed position when the pin 74 is in the first position 82 without the shear pin 54. This is because no mechanism or locating features are located at the channel 78 to stop the pin 74 from sliding into the second position 90.

On the other hand, the pin 74 may be retained along the third position 92 to lock the hinge mechanism 24 closed. This is because the second end 96 of the channel 78 may act as a stopper to retain the pin 74 in the third position 92. Thus, although the spring 76 is still exerting the torque T, the pin 74 has nowhere to travel inside of the channel 78. Thus, the torque T keeps the pin 74 retained in the third position 92. The geometry of the channel 78 may also include a bend 104 that may be located along a portion 114 of the channel 78. The bend 104 may facilitate rotation of the cam 72 from the second position 90 and into the third position 92.

The pin 74 may also be retained in place in the third position 92 because the first hinge strap 50 includes the slotted hole 98. FIG. 6 illustrates the pin 74 in engagement with the slotted hole 98, which may also be used for limiting travel inside of the channel 78 when the torque T is exerted by the spring 76. More specifically, movement of the pin 74 may be restricted to the slotted hole 98. Having the pin 74 travel inside the slotted hole 98 will provide additional structural integrity. This is because the pin 74 is limited in travel by a first stop 100 and a second stop 102 of the slotted hole 98, and therefore exerts less force on the cam 72.

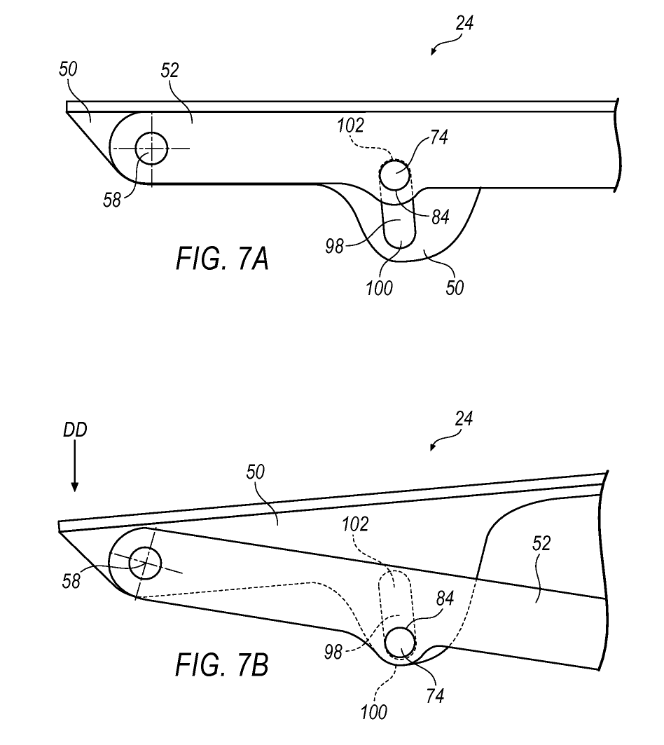

The slotted hole 98 also retains the pin 74 in the first position 82 and the second position 90. More specifically, the slotted hole 98 acts as a hard stop when the pin 74 travels from the first position 82 to the second position 90. The pin 74 rests against the first stop 100 of the slotted hole 98 when the hinge mechanism 24 is deployed into the open position. Thus, the slotted hole 98 aids in limiting deployment travel of the hood 32 to the predetermined distance D. In the illustration as shown in FIGS. 7A and 7B, the slotted hole 98 is generally linear in shape. However, the slotted hole 98 may not be a linear slot and include other shapes as well. For example, the slotted hole 98 may be curved, or include an overall non-linear shape. Any shape of the slotted hole 98 may be used so long as the pin 74 may be able to travel in between two stops for retaining the predetermined distance D′ as the hinge mechanism 24 is urged into the open position. Indeed, the slotted hole 98 may include a variety of shapes and sizes.

FIG. 7A illustrates the hinge mechanism 24 as seen in FIG. 4 from the opposite side, and includes the first hinge strap 50, the second hinge strap 52, the pin 74 and the common pivot point 58. The pin 74 includes at least one attachment point 84 that is configured for connecting the pin 74 to the second hinge strap 52 of the hinge mechanism 24. When the pin 74 is in either of the first position 82 or the third position 92 of the channel 78, the second stop 102 of the slotted hole 98 will retain the pin 74. This means that the second stop 102 will aid in securing the pin 74 in place such that the pin 74 is unable to slide or shift substantially inside of the channel 78 during normal operating conditions. The pin 74 does not slide inside the channel 78 until an external event occurs, for example when the upwards force F is exerted from the shaft 40 on the first hinge strap 50 to break the shear pin 54.

FIG. 7B illustrates the hinge mechanism 24 as seen in FIG. 5 when the pin 74 is in the second position 90. The pin 74 may be retained at least in part by the slotted hole 98 at the second stop 102. That is, the pin 74 rests at the second stop 102. The first stop 100 may not allow for additional travel of the pin 74 in a downward direction DD. The first stop 100 aids in retaining the pin 74 in the second position 90 of the channel 78.

FIG. 8 is a partially exploded view of the cam assembly 60, including the cam 72, the spring 76, the pivotable pin 86, the pin 74 and a portion of the first hinge strap 50. As discussed above, the cam 72 rotates about the pivot point 80, and may be located at an axis A-A. The cam 72 may be connected to and acts on the first hinge strap 50 of the hinge mechanism 24 at the pivot point 80. In the illustration as shown, the cam 72 includes the mating hole 106 that receives the pivotable pin 86, and the pivotable pin 86 is rotatably connected to the first hinge strap 50. For example, FIG. 8 illustrates the pivotable pin 86 connected to the first hinge strap 50 by way of an aperture 108. The spring 76 includes an inner surface 110, and when the cam assembly 60 is assembled together, the inner surface 110 fits around and is in contact with an outer surface 112 of the pivotable pin 86.

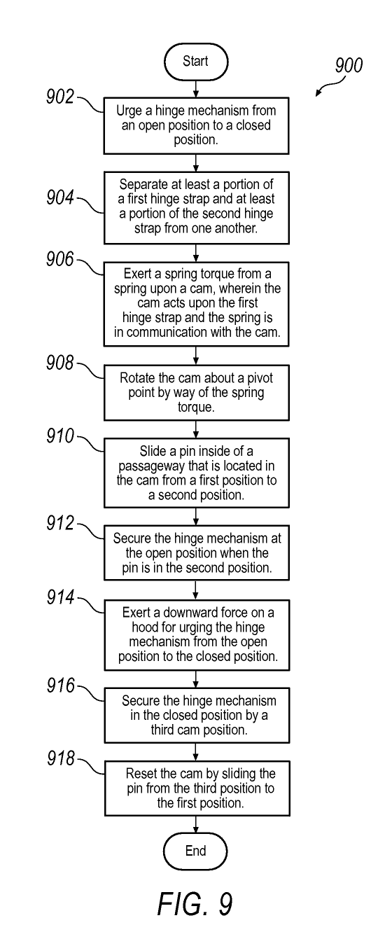

Turning now to FIG. 9, a process 900 of deploying the hood 32 of the vehicle 20 by the hinge mechanism 24 is illustrated. Process 900 may begin at step 902, where the hinge mechanism 24 is urged from a closed position to an open position. For example, as discussed above, when the shear pin 54 is broken, the hinge mechanism 24 may be urged into an open position by the upwards force F that is exerted from the shaft 40. The upwards force F may be exerted on at least the first hinge strap 50. The upper surface 70 of the first hinge strap 50 urges the hood 32 upwardly in the direction U and into the deployed position, as illustrated in FIG. 1B. Process 900 may then proceed to step 904.

In step 904, at least a position of the first hinge strap 50 and a portion of the second hinge strap 52 separate from one another. For example, as discussed above, the first hinge strap 50 may be generally aligned with the second hinge strap 52 when the hinge mechanism 24 is closed. FIG. 2A illustrates the upper surface 70 of the first hinge strap 50 generally parallel with the upper surface 71 of the second hinge strap 52. The predetermined distance D′ may be included between the first hinge strap 50 and the second hinge strap 52 when the hinge mechanism 24 is urged in the open position.

In the alternative illustration as seen in FIG. 3, the vertical distance is illustrated as the predetermined distance D″. In the illustration as shown, the predetermined distance D″ may increase between the first and second hinge straps 150 and 152 as the hinge mechanism 124 is urged into the open position. As the hinge mechanism 124 is urged open, the angle α′, as well as the predetermined distance D″ may increase between the first hinge strap 150 and the second hinge strap 152. Process 900 may then proceed to step 906.

In step 906, the spring torque T is exerted from the spring 76 upon the cam 72, where the cam 72 is connected to the first hinge strap 50, and the spring 76 is in communication with the cam 72. For example, as illustrated in FIGS. 4-6, the spring 76 may be wound about the shaft 88 of the pivotable pin 86. The first end 66 of the spring 76 rests at the side surface 68 of the first hinge strap 50, and the second end 48 of the spring 76 may be in contact with the outer surface 47 of the cam 72. The first end 66 and the second end 48 are bindingly engaged by the side surface 68 of the first hinge strap 50 and the outer surface 47 of the cam 72 respectively. Process 900 may then proceed to step 908.

In step 908, the cam 72 is rotated about the pivot point 80 by way of the spring torque T. For example, as discussed above, the cam 72 selectively rotates about the pivot point 80. The pivot point 80 may be the pivotable pin 86 that is received by the cam 72, where the cam 72 includes the mating hole 106 that receives the pivotable pin 86. When the shear pin 54 is broken, the hinge mechanism 24 is urged upwardly in the direction U, and the second end 48 of the spring 76 exerts the torque T upon the cam 72. The cam 72 is then rotated about the pivot point 80 by the spring torque T. Process 900 may then proceed to step 910.

In step 910, the pin 74 is slid inside of the channel 78. The channel 78 may be located in the cam 74 and is slid from the first position 82 to the second position 90. The pin 74 may be connected to and acts on the second hinge strap 52. As discussed above, the first position 82 corresponds to the hinge mechanism 24 in the closed position, and the second position 90 corresponds to the hinge mechanism 24 in the open configuration. That is, the pin 74 is located at the second position 90 when the hood 32 is deployed, as seen in the illustration of FIG. 1B. As discussed above, when the spring torque T is exerted and rotates the cam 72, the pin 74 is guided within the channel 78 from the first position 82 to the second position 90. Process 900 may then proceed to step 912.

In step 912, the hinge mechanism 24 is secured at the predetermined distance D′ when the pin 74 is in the second position 90. For example, as discussed above, the channel 78 may include geometry that facilitates retention of the pin 74 inside of the channel 78 and limits rotation of the hinge mechanism 24. In one illustration, the channel 78 includes a turn 77, which secures and assists in retaining the pin 74 in place when the pin 74 is in the second position 90. Moreover, the pin 74 may also be retained in place because the first hinge strap 50 includes the slotted hole 98. The slotted hole 98 may be used for limiting travel inside of the channel 78 when the torque T is exerted by the spring 76. The pin 74 is retained by the slotted hole 98 at the second stop 102 when the pin 74 is in the second position 90. The second stop 102 may not allow for additional travel of the pin 74 in the downward direction DD. Process 900 may then proceed to step 914.

In step 914, the downwards force DF is exerted on the hood 32 of the vehicle 20, urging the hinge mechanism 24 from the open position into the closed position. For example, as discussed above, a user may apply the force DF after the hood 32 has been deployed. When the downward force DF is exerted, the hood 32 is urged from the deployed position as seen in FIG. 1B to a post-deployment position, similar to the configuration as seen in FIG. 1A. The user may reposition the hood 32 such that the hood 32 is flush with the fender 44. Process 900 may then proceed to step 916.

In step 916, the hinge mechanism 24 is secured in the closed position by the third cam position 92. The pin 74 may be guided within the channel 78 and slidable from the second cam position 90 to the third cam position 92. The third cam position 92 limits rotation of the hinge mechanism 24. More specifically, as discussed above, the channel 78 may include the second end 96 that acts as a stopper to retain the pin 74 in the third position 92. Therefore, although the spring 76 may still be exerting the torque T, the pin 74 has nowhere to travel inside of the channel 78. Process 900 may then proceed to step 918.

In step 918, the cam system 60 is reset. The cam system 60 is reset by sliding the pin 74 inside of the channel 78 from the third cam position 92 to the first cam position 90. As discussed above, during servicing the cam 72 is repositioned back to the first position 82 such that the protection system 22 may be deployed again. The cam system 60 is repositioned by rotating the cam 72 in an opposite direction from the first, second and third positions D1, D2 and D3, thereby sliding the pin 74 from the third position 92 to the first position 82. This repositioning may be done manually, that is, no special tools or equipment may be needed to slide the pin 74 inside of the channel 78. Process 900 may then terminate.

The present disclosure has been particularly shown and described with reference to the foregoing illustrations, which are merely illustrative of the best modes for carrying out the disclosure. It should be understood by those skilled in the art that various alternatives to the illustrations of the disclosure described herein may be employed in practicing the disclosure without departing from the spirit and scope of the disclosure as defined in the following claims. It is intended that the following claims define the scope of the disclosure and that the method and apparatus within the scope of these claims and their equivalents be covered thereby. This description of the disclosure should be understood to include all novel and non-obvious combinations of elements described herein, and claims may be presented in this or a later application to any novel and non-obvious combination of these elements. Moreover, the foregoing illustrations are illustrative, and no single feature or element is essential to all possible combinations that may be claimed in this or a later application.

What is claimed is:

1. A hinge mechanism for deploying a vehicle pedestrian protection system, comprising:
a first hinge element and a second hinge element, the hinge elements positioned in relationship to each other;
a closed position and an open position, wherein at least a portion of the first hinge element and at least a portion of the second hinge element separate from one another when the hinge mechanism is urged from the closed position to the open position;
a cam assembly including a cam and a retaining mechanism, wherein the cam includes a pivot point and the cam selectively rotates about the pivot point, the cam connected the first hinge element and the retaining mechanism connected to the second hinge element; and
a first cam position corresponding to the closed position and a second cam position corresponding to the open position, wherein the retaining mechanism is guided within the cam between the first cam position and the second cam position;
wherein the cam is configured for rotating about the pivot point at least when the hinge mechanism is urged from the closed position into the open position, and the rotation of the cam moves the retaining mechanism from the first cam position to the second cam position.

2. The hinge mechanism as recited in claim 1, wherein the first hinge element includes a slotted hole, and the retaining mechanism is in engagement with the slotted hole for securing the hinge mechanism in the open position.

3. The hinge mechanism as recited in claim 1, further comprising a passageway located within the cam, the passageway including the first cam position and the second cam position, and wherein the retaining mechanism is guided inside the passageway and slidable between the first cam position to the second cam position.

4. The hinge mechanism as recited in claim 3, wherein the passageway is shaped in a generally J-shaped configuration, and the J-shape includes a first end and a second end, the retaining mechanism slidable between the first end and the second end.

5. The hinge mechanism as recited in claim 3, further comprising a third cam position, the retaining mechanism guided within the passageway and slidable from the second cam position to the third cam position, and the retaining mechanism being located at the third cam position when the hinge mechanism is in the closed position.

6. The hinge mechanism as recited in claim 5, wherein the third cam position secures the hinge mechanism in the closed position by limiting rotation of the cam.

7. The hinge mechanism as recited in claim 5, wherein the second cam position is located at about a midpoint of the passageway between the first cam position and the third cam position.

8. The hinge mechanism as recited in claim 1, further comprising a biasing mechanism exerting a biasing torque upon the cam, wherein the biasing torque urges the cam to rotate about the pivot point.

9. The hinge mechanism as recited in claim 1, further comprising a shear pin that is assembled to both the first hinge element and the second hinge element and secures the hinge mechanism in the closed position.

10. The hinge mechanism as recited in claim 9, wherein the shear pin is broken when an actuator exerts an upwards force greater than a threshold on at least the first hinge element, the upwards force urging the hinge mechanism into the open position.

11. The hinge mechanism as recited in claim 1, wherein the hinge mechanism is deployed into the open position when a front end of a vehicle contacts a living being, and the hinge mechanism is retained in the closed position when the front end of the vehicle contacts an inanimate object.

12. A hinge mechanism for deploying a vehicle pedestrian protection system, comprising:
a first hinge element and a second hinge element, the hinge elements positioned in relationship to each other;
a closed position and an open position, wherein at least a portion of the first hinge element and at least a portion of the second hinge element separate from one another when the hinge mechanism is urged from the closed position to the open position;
a cam assembly including a cam, a retaining mechanism and a biasing mechanism, the biasing mechanism exerting a biasing torque upon the cam, wherein the cam includes a pivot point and the cam selectively rotates about and is connected to the first hinge element at the pivot point, the retaining mechanism connected to the second hinge element; and
a passageway located within the cam and including a first cam position corresponding to the closed position and a second cam position corresponding to the open position, wherein the retaining mechanism is guided within the passageway between the first cam position and the second cam position;
wherein the biasing torque is configured for rotating the cam about the pivot point when the hinge mechanism is urged from the closed position into the open position, and the rotation of the cam slides the retaining mechanism inside the passageway from the first cam position to the second cam position.

13. The hinge mechanism as recited in claim 12, wherein the first hinge element includes a slotted hole, and the retaining mechanism is in engagement with the slotted hole to limit travel inside of the passageway when the biasing torque is exerted and secures the hinge mechanism in the open position.

14. The hinge mechanism as recited in claim 12, further comprising a shear pin that is assembled to both the first hinge element and the second hinge element and secures the hinge mechanism in the closed position.

15. The hinge mechanism as recited in claim 14, wherein the shear pin is broken when an actuator exerts an upwards force greater than a threshold on at least the first hinge element, the upwards force urging the hinge mechanism into the open position.

16. The hinge mechanism as recited in claim 12, further comprising a third cam position, the retaining mechanism guided within the passageway and slidable from the second cam position to the third cam position, and the retaining mechanism being located at the third cam position when the hinge mechanism is secured in the closed position.

17. The hinge mechanism as recited in claim 12, wherein the passageway is shaped in a generally J-shaped configuration, and the J-shape includes a first end and a second end, the retaining mechanism slidable between the first end and the second end.

18. A method of deploying a hood of a vehicle pedestrian protection system by a hinge mechanism, comprising the steps of:
urging the hinge mechanism from a closed position to an open position for deploying a hood of a vehicle pedestrian protection system;
separating at least a portion of a first hinge element and at least a portion of a second hinge element from one another to urge the hinge mechanism from the closed position to the open position;
exerting a biasing torque from a biasing mechanism upon a cam, wherein the cam is connected to the first hinge element and the biasing mechanism is in communication with the cam;
rotating the cam about a pivot point by way of the biasing torque;
sliding a retaining mechanism inside of a passageway that is located in the cam from a first cam position to a second cam position, the retaining mechanism connected to the second hinge element, and the first and second cam positions located along the passageway; and
securing the hinge mechanism at the open position when the retaining mechanism is in the second cam position;
wherein the retaining mechanism is located at the first cam position when the hinge mechanism is in the closed position and the retaining mechanism is in the second cam position when the hinge mechanism is in the open position.

19. The method as recited in claim 18, wherein a shear pin is broken to urge the hinge mechanism from the closed position to the open position, wherein the shear pin is assembled to both the first hinge element and the second hinge element and secures the hinge mechanism in the closed position.

20. The method as recited in claim 19, wherein an upwards force is exerted on at least the first hinge element, the upwards force breaking the shear pin.

21. The method as recited in claim 18, further comprising the step of exerting a downwards force on a hood of the vehicle for urging the hinge mechanism from the open position into the closed position.

22. The method as recited in claim 21, further comprising the step of securing the hinge mechanism in the closed position by a third cam position, the retaining mechanism guided within the passageway and slidable from the second cam position to the third cam position, and the third cam position limiting rotation of the hinge mechanism.

23. The method as recited in claim 22, further comprising the step of resetting the by sliding the retaining mechanism inside of the passageway from the third cam position to the first cam position.
